(19) United States
(12) Patent Application Publication
(10) Pub. No.: US 2025/0346176 A1
(43) Pub. Date: Nov. 13, 2025

(54) RECREATIONAL VEHICLES WITH CABINET STRUCTURES COMPRISING TUBULAR SUPPORTS

(71) Applicant: Thor Tech, Inc., Elkhart, IN (US)

(72) Inventors: Trent Tobolski, Granger, IN (US); Steve Romanowski, Albion, IN (US); Vishnu Ramkumar, Kalamazoo, MI (US)

(21) Appl. No.: 18/657,054

(22) Filed: May 7, 2024

(51) Int. Cl. B60P 3/36; A47B 77/02; A47B 96/20

(52) U.S. Cl. CPC B60P 3/36; A47B 77/02; A47B 96/20

(57) ABSTRACT

A recreational vehicle may comprise a cabinet structure in contact with a horizontal floor and one upstanding wall, the cabinet structure comprising a plurality of generally planar side panels, each of the plurality of side panels comprising a plurality of channels extending between first and second side panel faces. The cabinet structure may also comprise a plurality of tubular supports, wherein each tubular support is sized to fit through the channels of the plurality of side panels; each tubular support extends from the channel of one of the plurality of side panels to a corresponding channel of another of the plurality of side panels; and the tubular supports interconnect the plurality of sides panels, thereby providing rigidity to the cabinet structure.

### TECHNICAL FIELD

Embodiments of the present disclosure generally relate to recreational vehicles and cabinet structures, and particularly to cabinet structures comprising tubular supports, such as for recreational vehicles.

### BACKGROUND

Recreational vehicles (RVs) take a variety of forms (pull-type trailer, self-propelled, etc.) and are manufactured using different manufacturing methods. The chassis' of such recreational vehicles may often be pre-fabricated prior to filling out the inside with kitchen fixtures, cabinetry, and other amenities. Accordingly, kitchen fixtures, cabinetry, and other amenities desired to be fitted into the recreational vehicles may be size constrained by the entrances to the recreational vehicle itself.

Moreover, as the size of recreational vehicles can vary greatly, it may be desired to transport the individual parts of the cabinetry into the recreational vehicle separately. Furthermore, consumers' wants in terms of cabinetry and kitchen fixtures may vary, such that it may be desired that the components of the cabinetry be useable for a variety of configurations of cabinetry and/or kitchen fixtures. Further yet, consumers' wants may vary over time, such that it may be desired that the cabinetry (such as but not limited to shelf height, shelf width, or cabinet sizing) may be adjustable per the consumers changing needs. Finally, some kitchen fixtures may break over time, resulting in a need to replace fixtures with alternative fixtures. Accordingly, it may be desired that the cabinetry be adjustable even after being initially installed.

### SUMMARY

According to embodiments herein, cabinetry is provided for a recreational vehicle that satisfies one or more of the aforementioned desires. Particularly, a plurality of sub-panels are provided that each comprise features for mounting and supporting components such as drawers, shelves, kitchen fixtures, and cabinets. The configuration of these features, including ledges, guide holes, and/or mounting apertures, also allow the position and sizing of the components to vary, providing considerable flexibility in assembly of the cabinetry across the spectrum of consumer preference. Moreover, reinforcement panels may be provided to the cabinetry systems herein for providing additional flexibility and support.

In accordance with one embodiment of the present disclosure, a recreational vehicle of the type comprising a chassis with at least one axle may comprise a generally horizontal floor; a vehicle body comprising a plurality of generally upstanding walls each comprising a bottom adjacent the floor and a top distal to the floor; and a cabinet structure in contact with the generally horizontal floor and one of the upstanding walls.

In another embodiment, or at least according to the previous embodiment, the cabinet structure may comprise a plurality of generally planar side panels, each of the plurality of side panels comprising: a rear edge disposed proximate to one of the upstanding walls; an opposed front edge distal to one of the upstanding walls; a lower edge adjacent the horizontal floor; an upper edge distal to the floor; opposed first and second panel faces extending generally between the front and rear edges and the upper and lower edges; and a plurality of channels extending between the first and second side panel faces.

According to the previous embodiment, the cabinet structure may further comprise a plurality of tubular supports, wherein: each tubular support is sized to fit through the channels of the plurality of side panels; each tubular support extends from the channel of one of the plurality of side panels to a corresponding channel of another of the plurality of side panels; and the tubular supports interconnect the plurality of sides panels, thereby providing rigidity to the cabinet structure.

In accordance with yet another embodiment of the present disclosure, a cabinet structure may comprise a plurality of generally planar side panels, each of the plurality of side panels comprising: a rear edge; a front edge opposed to the rear edge; a lower edge; an upper edge opposed to the lower edge; opposed first and second panel faces extending generally between the front and rear edges and the upper and lower edges; a plurality of channels extending between the first and second side panel faces; and a plurality of tubular supports, wherein: each tubular support is sized to fit through the channels of the plurality of side panels, each tubular support extends from the channel of one of the plurality of side panels to a corresponding channel of another of the plurality of side panels, and the tubular supports interconnect the plurality of sides panels, thereby providing rigidity to the cabinet structure.

Although the concepts of the present disclosure are described herein with primary reference to cabinetry for recreational vehicles, it is contemplated that the concepts will enjoy applicability to any cabinetry. For example, and not by way of limitation, it is contemplated that the concepts of the present disclosure will enjoy applicability to cabinetry for commercial, workplace, and domestic settings.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates an exploded view of a recreational vehicle with a cabinet structure, according to embodiments herein;

FIG. 2A illustrates a closer view of the cabinet structure including one or more cosmetic panels, one or more kitchen fixtures, and at least one side panel illustrated, according to embodiments herein;

FIG. 2B illustrates a back view of the cabinet structure of FIG. 2A, according to embodiments herein;

FIG. 3A illustrates the cabinet structure of FIG. 2A, primarily illustrating the plurality of side panels, i.e., with the one or more cosmetic panels and one or more kitchen fixtures not included, according to one or more embodiments herein;

FIG. 3B illustrates a side perspective view of the cabinet structure of FIG. 3A, according to embodiments herein;

FIG. 4A illustrates a side-view of a variation of the side panel of FIGS. 2A-2B, the side panel comprising a plurality of ledges, openings, and guide holes for mounting additional features, according to embodiments herein;

FIG. 4B illustrates a side-view of a variation of the side panel of FIGS. 2A-2B, the side panel comprising a plurality of mounting apertures and a plurality of sub-panels arranged in a grid, according to embodiments herein;

FIG. 5 illustrates a perspective view of the side panel of FIG. 4B, also showing a plurality of reinforcement panels, according to embodiments herein;

FIG. 6A illustrates front and back views of a ‘ledge-type’ reinforcement panel such as for mounting shelves, according to embodiments herein;

FIG. 6B illustrates the ‘ledge-type’ reinforcement panels mounted on the plurality of side panels, supporting a shelf, according to embodiments herein;

FIG. 7A illustrates front and back views of a ‘drawer-type’ reinforcement panel, such as for mounting a drawer slide and supporting a drawer, according to embodiments herein;

FIG. 7B illustrates the ‘drawer-type’ reinforcement panel mounted on the plurality of side panels and supporting a drawer slide, according to embodiments herein;

FIG. 8A illustrates front and back views of a ‘support-type’ reinforcement panel, such as for mounting a hinge for supporting an external feature, according to embodiments herein;

FIG. 8B illustrates the ‘hinge-support-type’ reinforcement panel mounted on the plurality of side panels and for supporting an external feature, such as a ledge or hinge for a cabinet door; and

FIG. 9 illustrates a common side panel with an attached extension panel, according to embodiments herein.

### DETAILED DESCRIPTION

Embodiments of the present disclosure generally relate to recreational vehicles and cabinet structures, and particularly to cabinet structures comprising tubular supports, such as for recreational vehicles. As used herein, the term “proximal” means closer to an element. The term “distal” means further from the element.

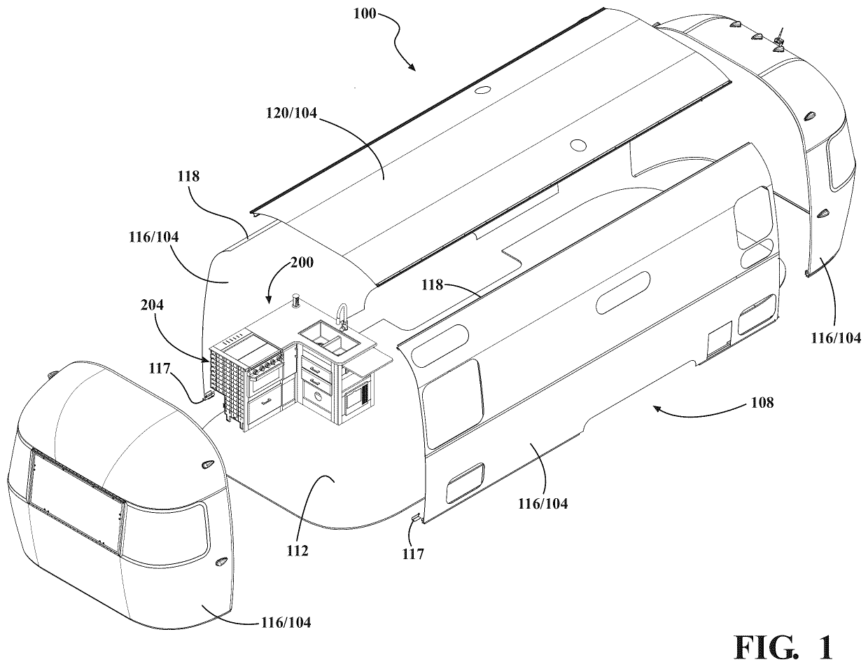

Now referring to FIG. 1, illustrated is a recreational vehicle 100 (RV), particularly an exploded view of a recreational vehicle 100 shell. As shown in FIG. 1, the RV 100 may comprise a vehicle body 104, an axle 108, and a generally horizontal floor 112. The vehicle body 104 may comprise a plurality of generally upstanding walls 116, as well as a roof 120. Each of the generally upstanding walls 116 may comprise a bottom 117 adjacent the generally horizontal floor 112 and a top 118 distal to the generally horizontal floor 112. As also shown in FIG. 1, the RV 100 may also comprise a cabinet structure 200. As shown in FIG. 1, the cabinet structure 200 may be in contact with the generally horizontal floor 112 and one of the upstanding walls 116.

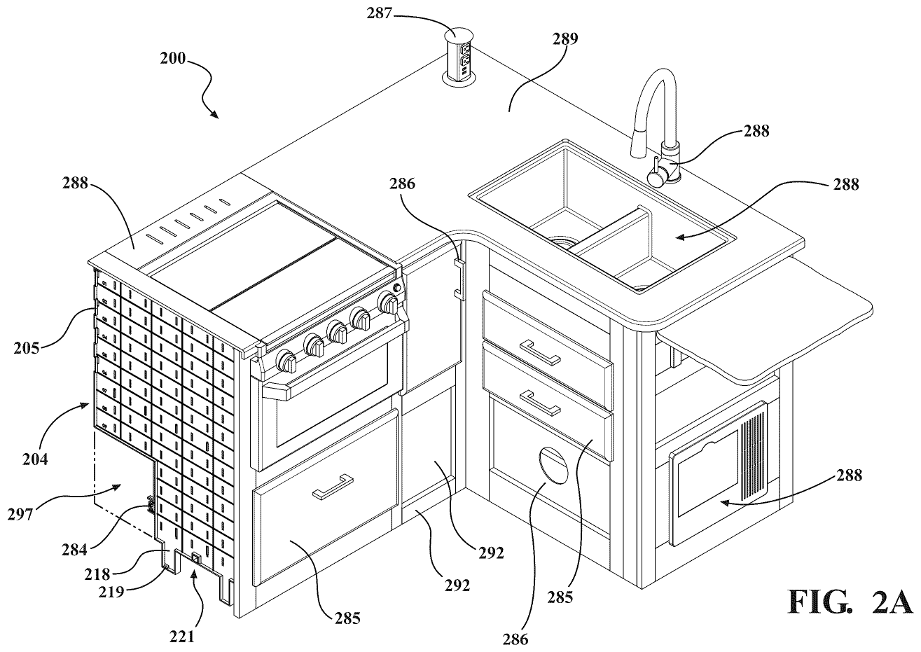

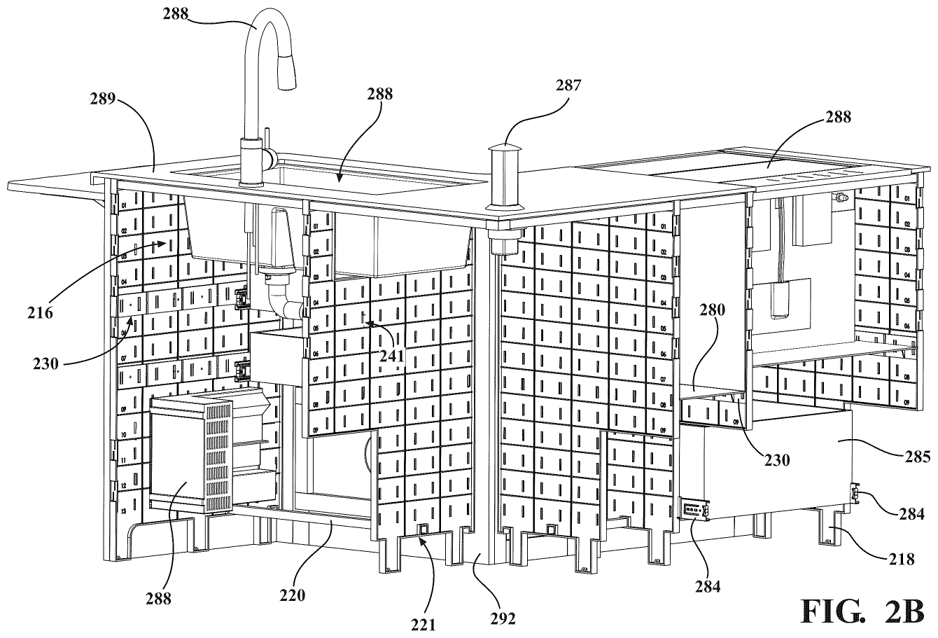

Now referring to FIGS. 2A-2B, illustrated is a closer view of the cabinet structure 200 in front (FIG. 2A) and reverse (FIG. 2B) views. As shown in FIGS. 2A-2B, the cabinet structure 200 may comprise a plurality of generally planar side panels 204. As also shown in FIG. 2A, the cabinet structure 200 may comprise a countertop 289, a plurality of cosmetic panels 292, or both. The countertop 289 may be disposed on upper edges 208 of the plurality of side panels 204, as explained in further detail herein. The plurality of cosmetic panels 292 each may be disposed on an exterior of the plurality of side panels 204, as explained in further detail herein. Moreover, the cabinet structure 200 may also comprise one or more drawers 285, one or more cabinets 286, one or more power outlets 287, one or more kitchen fixtures 288, or combinations thereof, as explained in further detail herein.

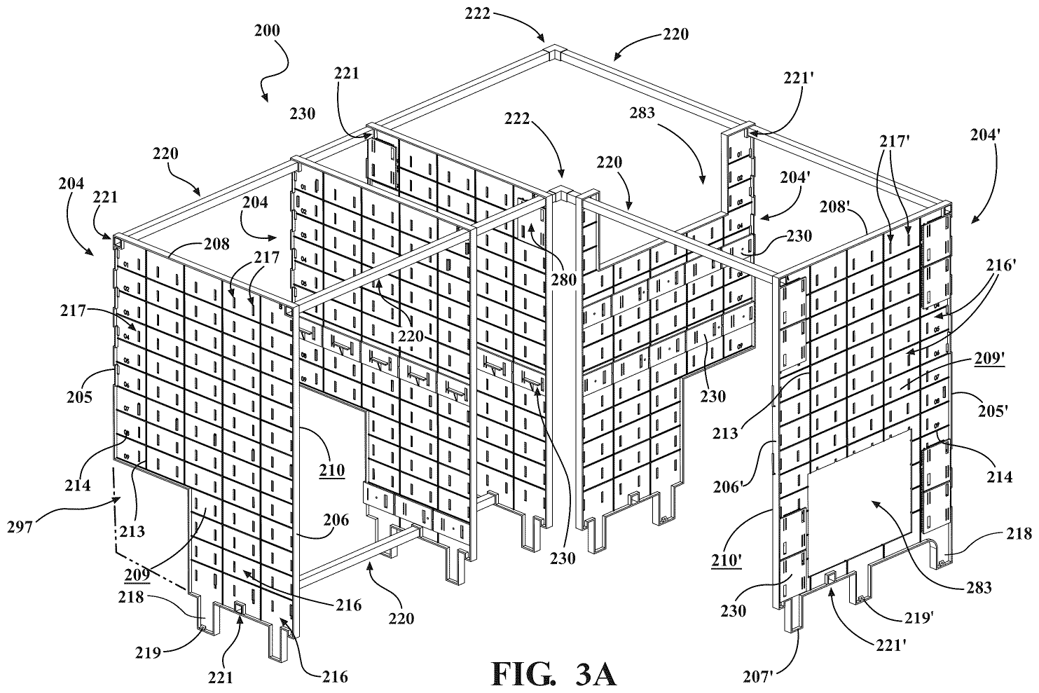

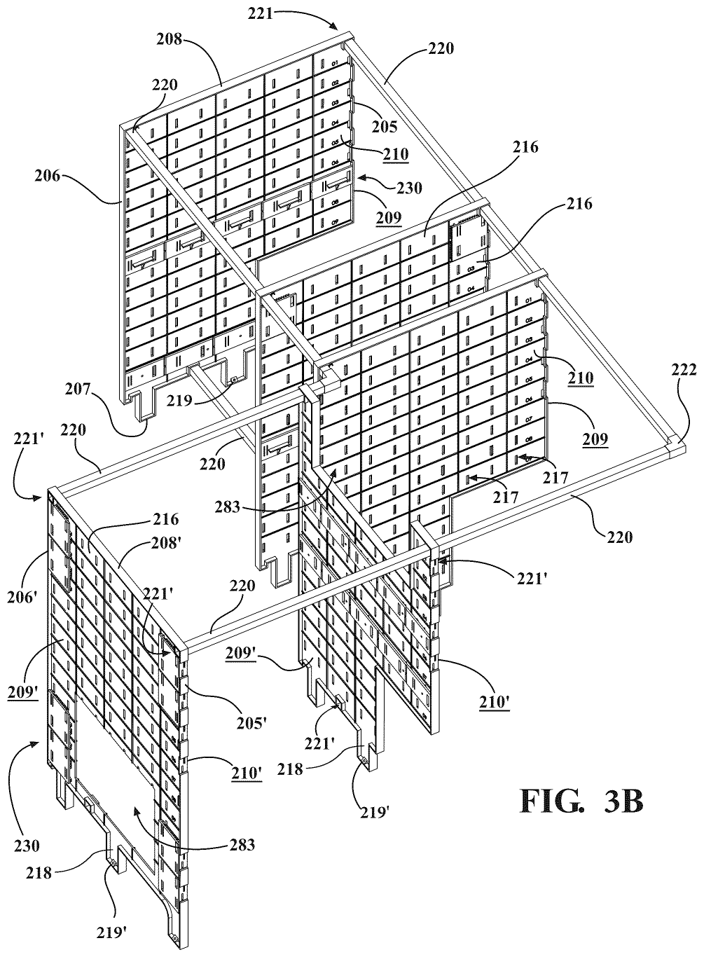

Now referring to FIGS. 3A-3B, illustrated is the cabinet structure 200 in front (FIG. 3A) and side (FIG. 3B) views without the countertop 289, the one or more drawers 285, the one or more cabinets 286, the one or more power outlets 287, the one or more kitchen fixtures 288, and the plurality of cosmetic panels 292 illustrated.

As previously stated, the cabinet structure 200 comprises the plurality of generally planar side panels 204. As shown in FIGS. 3A-3B, at least some of the plurality of side panels 204 may be parallel to each other. The plurality of side panels 204 may additionally or alternatively be perpendicular to at least one of the plurality of upstanding walls 116.

In at least some embodiments, and as shown in FIGS. 3A-3B, the cabinet structure 200 may also comprise a second plurality of generally planar side panels 204′, such that the plurality of side panels 204 may also be regarded as a first plurality of side panels 204. The second plurality of side panels 204′ may be similar or identical to the first plurality of side panels 204, such that further descriptions of “the plurality of side panels 204”, “side panels”, or any sub-components therein may refer to either the first plurality of side panels 204 or the second plurality of side panels 204′.

As shown in FIGS. 3A-3B, the second plurality of side panels 204′ may be perpendicular to the first plurality of side panels 204. Similar to the first plurality of side panels 204, at least some of the second plurality of side panels 204′ may be parallel to each other. The second plurality of side panels 204′ may additionally or alternatively be parallel to at least one of the plurality of upstanding walls 116.

Still referring to FIGS. 3A-3B, and in embodiments, each of the plurality of side panels 204 may comprise a rear edge 205, a front edge 206, a lower edge 207, an upper edge 208, a first panel face 209, and a second panel face 210. The rear edge 205 may be disposed proximate to one of the upstanding walls 116. The front edge 206 may oppose the rear edge 205 and may be distal to one of the upstanding walls 116. The lower edge 207 may be adjacent the generally horizontal floor 112. The upper edge 208 may oppose the lower edge 207 and/or may be distal to the generally horizontal floor 112. The first and second panel faces 209/210 may oppose each other, and may also extend generally between the front edge 206 and rear edge 205 and the upper edge 208 and the lower edge 207 of the side panel 204.

As also shown in FIGS. 3A-3B, the plurality of side panels 204 may further comprise a plurality of channels 221 extending between the first and second side panel faces 209/210 and a plurality of tubular supports 220. In embodiments, two or more of the plurality of side panels 204 may comprise channels 221 in matching positions.

While FIGS. 3A-3B illustrates the plurality of tubular supports 220 as square in cross-section, the plurality of tubular supports 220 may be any shape, including but not limited to any triangular shape, polygonal shape, circular shape, elliptical shape, or any variation or sub-combination thereof. As also shown in FIGS. 3A-3B, the tubular supports 220 may be sized to fit through the plurality of channels 221 of the plurality of side panels 204. Accordingly, as also shown, at least one of the tubular supports 220 may extend from one of the channels 221 of one of the first plurality of side panels 204 to another channel 221 of the first plurality of side panels 204. In such manner, the plurality of tubular supports 220 may interconnect the plurality of side panels 204 while also providing rigidity to the cabinet structure 200.

Moreover, as also shown in at least FIGS. 3A-3B, at least one of the plurality of channels 221 may be proximal a corner of the side panel defined by the rear edge 205 and the upper edge 208, the corner defined by the front edge 206 and the upper edge 208, the corner defined by the rear edge 205 and the lower edge 207, the corner defined front edge 206 and the lower edge 207 or combinations thereof. Although not illustrated, it is contemplated that at least some of the plurality of channels may be located at any position on the side panel, depending on the configuration of the plurality of sub-panels and the sub-components, such as the kitchen fixtures, used therein. Furthermore, as shown in FIG. 3B, not all of the plurality of channels 221 may be filled with the tubular supports 220, depending on the configuration.

As further shown in FIG. 3B, at least some of the plurality of tubular supports 220 may extend through three of more of the plurality of side panels 204, thereby providing further structure and/or rigidity to the cabinet structure 200. For example, in such embodiments comprising the second plurality of side panels 204′, at least one of the tubular supports 220 may comprise an elbow joint 222, such that the tubular support 220 comprising the elbow joint 222 may extend from one of the channels 221 of one of the first plurality of side panels 204 to one of the channels 221′ of the second plurality of side panels 204′. In such manner, the plurality of tubular supports 220 may interconnect the first and second pluralities of side panels 204/204′ while also providing rigidity to the cabinet structure 200.

However, while the plurality of channels 221 and the plurality of tubular supports 220 are illustrated and stated as one method for interconnecting the plurality of side panels 204 and/or providing rigidity to cabinet structure 200, other methods are also contemplated. For example, a plurality of generally horizontal members (not shown), such as a third plurality of side panels (not shown), may be adjacent or proximal the rear edge 205 of at least some of the plurality of side panels 204, thereby interconnecting at least some of the plurality of side panels 204 and providing rigidity to the cabinet structure 200. Additionally or alternatively, the rear edge 205 of at least some of the plurality of side panels 204 may be coupled to at least one of the upstanding walls 116, thereby providing the rigidity to the cabinet structure 200. In embodiments with at least one of the tubular supports 220 adjacent the rear edge 205 of the plurality of sub-panels 204, the at least one of the tubular supports 220 may additionally or alternatively be coupled to the at least one of the upstanding walls 116.

Moreover, as shown in at least FIGS. 2A-3B, at least some of the plurality of side panels 204 may comprise at least one floor mount 219, which may comprise a floor mount guide hole for receiving a fastener for securing the side panel 204 to the generally horizontal floor 112 and providing the rigidity to the cabinet structure 200. The fastener may be any fastener understood in the art, including but not limited to a bolt, a screw, a nail, a magnetic fastener, or combinations thereof.

As previously stated, at least some of the plurality of side panels 204 may comprise the at least one floor mount 219. In at least some embodiments, the at least one floor mount 219 may be housed in at least one protrusion 218 extending from the lower edge 207 of at least some of the plurality of side panels 204. The at least one protrusion 218 may itself be in contact with the generally horizontal floor 112, and may be configured to support the weight of the side panel 204 and any attached elements thereto.

Alternatively or additionally, at least some of the plurality of side panels 204 may comprise a weight-bearing element (not shown) adjacent the lower edge 207 of the side panel 204 and in contact with the generally horizontal floor 112. The at least one weight-bearing element may also comprise the at least one floor mount 219.

Now referring to FIGS. 2A-3B, and as previously stated, each of the plurality of side panels 204 may comprise the rear edge 205. In at least some embodiments, at least a portion of the rear edge 205 of at least some of the plurality of side panels 204 may be spaced from the upstanding wall, such that a recess 297 is defined. In embodiments, the recess 297 may be sized to accept ducting for heating, ventilation, and air conditioning (HVAC).

Referring to FIGS. 2A-2B, and as previously stated, the cabinet structure 200 may comprise the one or more power outlets 287, the one or more kitchen fixtures 288, or both. The one or more power outlets 287 may comprise the power outlet, as well as, but not limited to, associated housings, brackets, and electric wiring for supplying power to the power outlet. The one or more kitchen fixtures 288 may include, but may not be limited to a sink, a stovetop, an oven, a fridge, a freezer, a microwave, a dishwasher, or combinations thereof.

Still referring to FIGS. 2A-2B, and as previously stated, the cabinet structure 200 may further comprise the one or more drawers 285, the one or more cabinets 286, the one or more power outlets 287, the one or more kitchen fixtures 288, or combinations thereof. Accordingly, the plurality of side panels 204 may comprise a plurality of openings 283. The plurality of openings 283 may be sized to receive the one or more drawers 285, the one or more cabinets 286, the one or more power outlets 287, the one or more kitchen fixtures 288, or combinations thereof. Alternatively or additionally, a spacing between at least some of the plurality of the of side panels 204 may be sized to receive the one or more drawers 285, the one or more cabinets 286, the one or more power outlets 287, the one or more kitchen fixtures 288, or combinations thereof. Similarly, the countertop 289 may have the plurality of openings 283 for receiving the one or more kitchen fixtures 288, the one or more power outlets 287, or both, such as for the sink, faucet, and stovetop shown in FIGS. 2A-2B.

In embodiments, the plurality of side panels 204 may comprise a length, measured from the rear edge 205 to the front edge 206, of approximately 21.75 inches, such as from 20 inches to 21 inches, from 21 inches to 21.75 inches, from 21.75 inches to 23 inches, from 23 inches to 24 inches, from 24 inches to 30 inches, or combinations of the ranges or smaller ranges therein, such as from 21 inches to 23 inches. The plurality of side panels 204 may comprise a height, measured from the lower edge 207 to the upper edge 208, of approximately 34 inches, such as from 27 inches to 28 inches, from 28 inches to 32 inches, from 32 inches to 34 inches, from 34 inches to 36 inches, from 36 inches to 40 inches, from 40 inches to 42 inches, or combinations of the ranges or smaller ranges therein, such as from 27 inches to 42 inches. Without being limited by theory, the length and height of the plurality of side panels may vary depending on the use of the cabinet structure, as well as whether an ADA compliant countertop is desired for the plurality of side panels. The plurality of side panels 204 may comprise a width, measured from the first panel face 209 to the second panel face 210, of approximately 0.75 inches, such as from 0.5 inches to 0.6 inches, from 0.6 inches to 0.75 inches, from 0.75 inches to 0.9 inches, from 0.9 inches to 1 inch, or combinations of the ranges or smaller ranges therein, such as from 0.5 inches to 1 inch.

In embodiments, the plurality of side panels may comprise a polyolefin, a thermoplastic or both. The polyolefin may include, but may not be limited to polypropylene (PP). The thermoplastic may include, but may not be limited to acrylonitrile butadiene styrene (ABS). The plurality of side panels may also comprise a glass fiber filler for additional reinforcement.

As previously stated, and as shown in FIGS. 2A-2B, the cabinet structure 200 may comprise the plurality of cosmetic panels 292. The plurality of cosmetic panels 292 may comprise particle board, plywood, wood, plastic, composites, or any other material that may be considered aesthetic for cabinetry. As shown in FIGS. 2A-2B, the plurality of cosmetic panels 292 may be coupled to at least one of the rear edge 205, the front edge 206, the upper edge 208, the lower edge 207, the first panel face 209, or the second panel face 210 of at least one of the plurality of side panels 204. Accordingly, the plurality of cosmetic panels 292 may cooperate to substantially obscure the said rear edge 205, front edge 206, upper edge 208, lower edge 207, first panel face 209, second panel face 210, or combinations thereof of one or more of the plurality of side panels 204 from an exterior view. In embodiments, the plurality of cosmetic panels 292 each may be coupled to one of the plurality of side panels 204 through a fastener, such as any of those fasteners previously discussed. Moreover, at least some of the plurality of side panels 204 may overlay a plurality of reinforcement panels 230 mounted to the side panel 204, as described in further detail herein, such that the plurality of reinforcement panels 230 may operate similar to a stud in drywall.

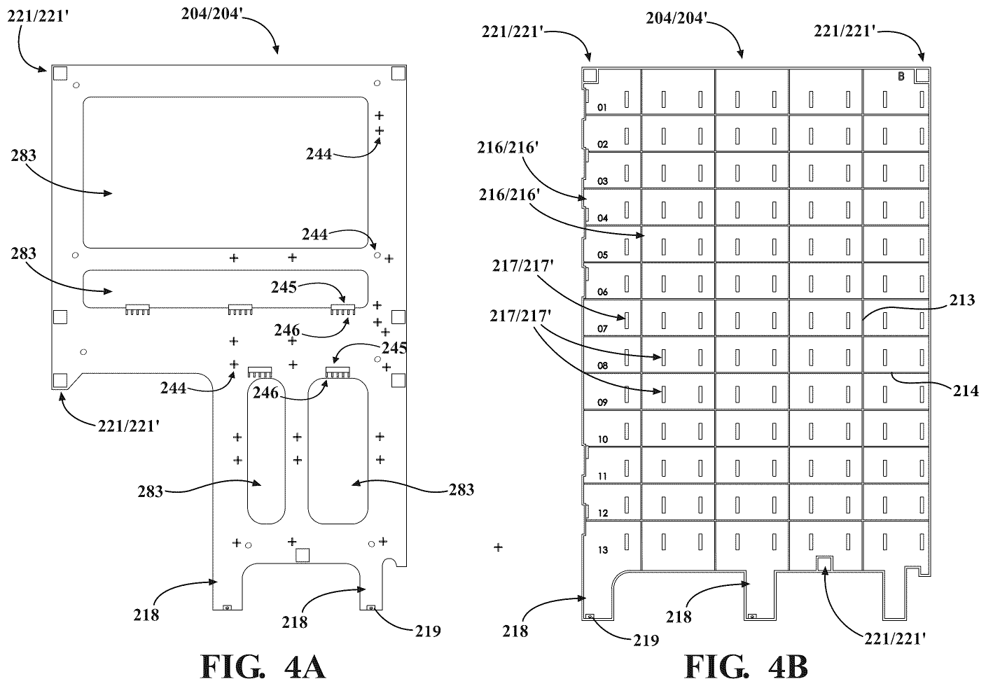

Now referring to FIGS. 4A-4B, illustrated are side views of two exemplary side panels 204, according to embodiments herein. As previously stated, each of the reinforcement panels 230 may comprise the rear edge 205, the front edge 206, the lower edge 207, the upper edge 208, and opposed first and second panel faces. However, as shown in FIG. 4A, at least some of the plurality of reinforcement panels 230 may comprise the plurality of openings 283, the plurality of openings 283 extending between the first and second side panel 204 faces. At least some of the plurality of reinforcement panels 230 may also comprise a plurality of ledges 245 extending from the first side panel 204 face, the second side panel 204 face, or both. As shown at least in FIG. 4A, the plurality of ledges 245 may be configured to support one or more shelves 280 within the cabinet structure 200, and may themselves be supported by a supporting bracket 246. At least some of the plurality of ledges 245 may also be adjacent the plurality of openings 283, although this is not required.

Still referring to FIG. 4A, at least some of the plurality of side panels 204 may further comprise a plurality of guide holes 244. The plurality of guide holes 244 may be configured to receive and/or support the mounting of an external component to the side panel 204, such as the plurality of reinforcement panels 230, as described in further detail herein.

Now referring to FIG. 4B, at least some of the plurality of side panels 204 may comprise a plurality of mounting apertures 217. The plurality of mounting apertures 217 may extend from the first panel face 209 to the second panel face 210, thereby defining a passage therethrough. As shown in FIG. 4B, the plurality of mounting apertures may be arranged in a grid. As also shown in FIG. 4B, at least some of the plurality of side panels 204 may comprise a plurality of generally vertical ribs 213 and generally horizontal ribs 214. The plurality of generally vertical and horizontal ribs 213/214 may also be interconnected, such that the plurality of generally vertical and horizontal ribs 213/214 may define a plurality of sub-panels 216 arranged in a grid. As used herein, grid generally refers to an at least 2 by 2 matrix, but may also include, but may not be limited to 2 by 3, 3 by 2, 3 by 3, etc. In at least some embodiments, and as shown in FIG. 4B, the grid may all or substantially of the first panel face 209, the second panel face 210, or both. Moreover, now referring back to FIGS. 3A and 3B, in at least some embodiments the plurality of vertical and horizontal ribs, and thereby the grids, on both the first panel face 209 and the second panel face 210 may be aligned, such that the plurality of side panels 204 resemble an I-beam when viewed from the rear edge 205 or the front edge 206.

Referring to FIG. 4B, the sub-panels 216 of the grid may be similar or identical to each other. For example, and in embodiments, at least one of the sub-panels 216 of the grid may comprise at least one of the plurality of mounting apertures 217. However, as shown in FIG. 4B, at least some of the sub-panels 216 of the grid may comprise two mounting apertures 217, and some of the sub-panels 216 of the grid may comprise one mounting aperture 217. In some embodiments each of the sub-panels 216 of the grid may comprise at least one of the plurality of mounting apertures 217.

In embodiments, the plurality of generally vertical and generally horizontal ribs 214 may have a thickness, measured outwards from the first panel face 209 or the second panel face 210 of approximately 0.075 inches, such as from 0.05 inches to 0.06 inches, from 0.06 inches to 0.075 inches, from 0.075 inches to 0.09 inches, from 0.09 inches to 0.1 inches, or combinations of the ranges or smaller ranges therein, such as from 0.06 inches to 0.09 inches.

The plurality of mounting apertures 217 may have a height, measured from a base of the aperture to a top 118 of the aperture, of from 0.75 inches to 1.25 inches. The plurality of mounting apertures 217 may also have a width, measured from one sidewall of the aperture to the other sidewall, of from 0.1 inches to 0.3 inches.

As previously stated, the plurality of side panels 204 may comprise the at least one protrusion 218. As shown in FIG. 4B, at least one of the sub-panels 216 adjacent the lower edge 207 of the side panel 204 may comprise the at least one protrusion 218 and/or the at least one weight-bearing element (not illustrated).

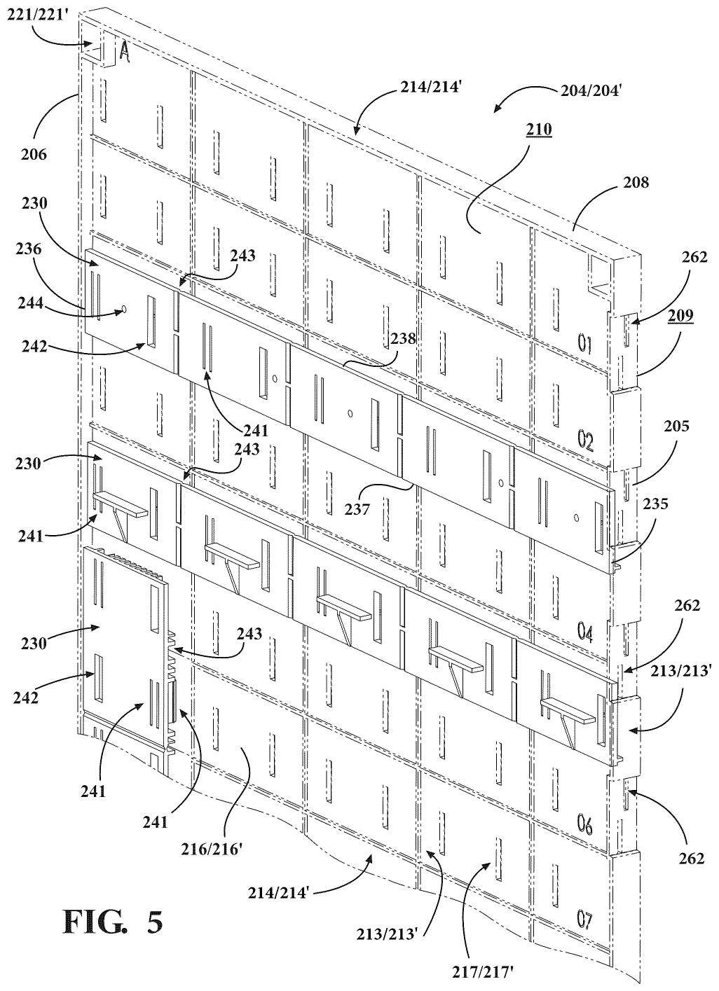

Now referring to FIGS. 5, shown is a perspective view of the side panel 204 further comprising a plurality of reinforcement panels 230. FIGS. 5-8B are intended to show the reinforcement panels 230 individually (5, 6A, 7A, 8A) as well as various placements of the various reinforcement panels 230 mounted on the plurality of side panels 204 (6B, 7B, 8B). For example, as shown in FIG. 5, the cabinet structure 200, and particularly at least some of the plurality of side panels 204, may comprise the plurality of reinforcement panels 230, each of the plurality of reinforcement panels 230 configured to anchor to at least one of the plurality of mounting apertures 217.

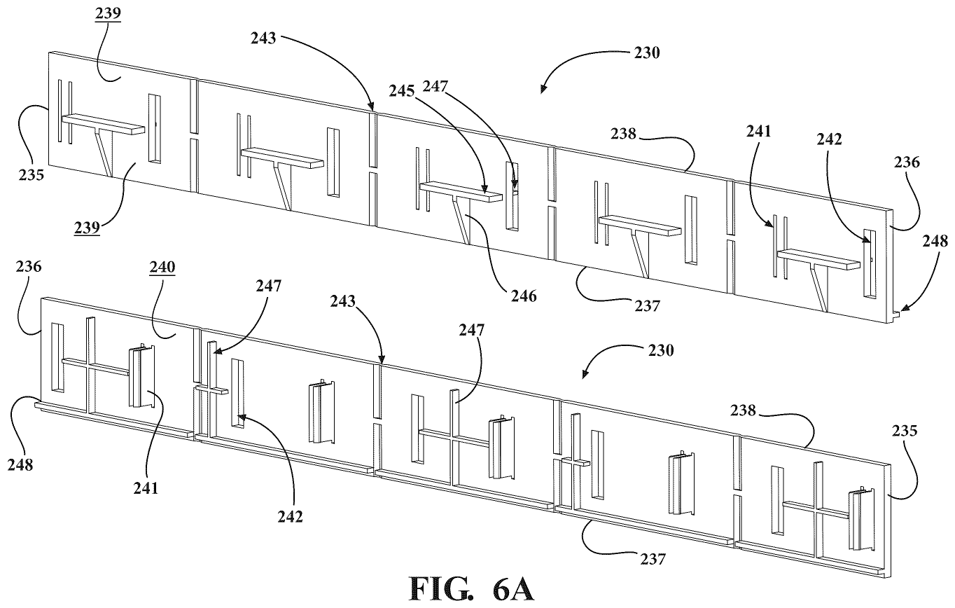

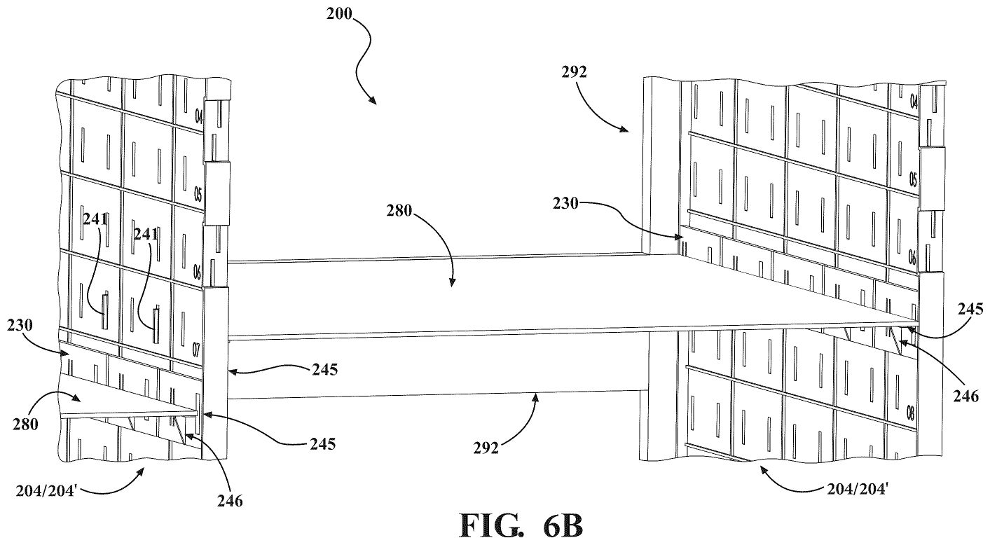

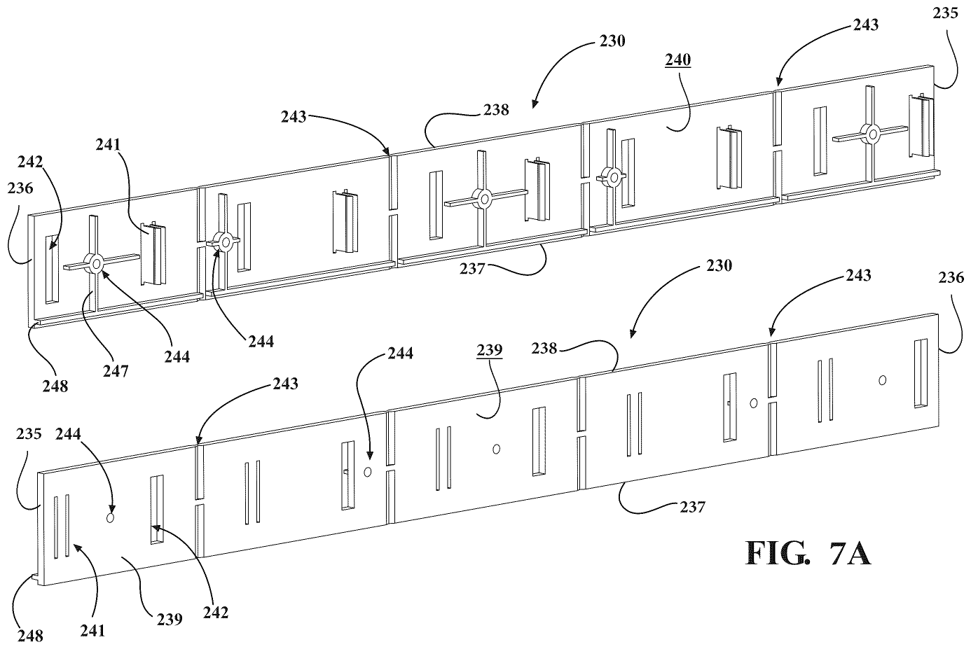

Similar to the plurality of side panels 204, and as shown in FIGS. 6A, 7A, and 8A, each reinforcement panel 230 may comprise a reinforcement panel rear edge 235, an opposed reinforcement panel front edge 236 to the reinforcement panel rear edge 235, a reinforcement panel lower edge 237, an opposed reinforcement panel upper edge 238 to the reinforcement panel lower edge 237, and opposed first and reinforcement panel second faces 239/240. As shown in FIG. 5, the reinforcement panel rear edge 235 may be proximal to the rear edge 205 of the side panel 204. Similarly, the reinforcement panel front edge 235 may be distal to the rear edge 205 of the side panel 204.

As previously stated, each of the plurality of reinforcement panels 230 may be configured to anchor to at least one of the plurality of mounting apertures 217 and/or at least one of the plurality of guide holes 244. Particularly, as shown in FIGS. 5-8B, the reinforcement panel second face 240 may be adjacent one of the first panel face 209 or the second panel face 210 of the side panel 204. As shown for example by the combination of FIGS. 6A-6B, at least some of the reinforcement panels 230 may anchor to the mounting apertures 217 through a snap fitting 241 protruding from the reinforcement panel second face 240. While cantilever-type snap fittings 241 are illustrated in FIGS. 6A-8B, any type of snap fitting 241 is contemplated, including but not limited to annular snap fittings (wherein the mounting aperture is flexible) or torsion snap fittings.

Alternatively or additionally, the plurality of reinforcement panels 230 may be configured to anchor to at least one of the plurality of guide holes 244 of FIG. 4A. In at least these embodiments, at least some of the plurality of reinforcement panels 230 may be configured to anchor to at least some of the plurality of guide holes 244, such as through the fasteners previous described.

Still referring to FIGS. 5-8B, the reinforcement panel 230 may be mounted to the side panel 204 through the snap fitting 241. Moreover, to support the snap fitting 241, at least some of the plurality of reinforcement panels 230 may be engaged with one of the horizontal ribs 214, such as one of the plurality of horizontal ribs 214 above or below the mounting aperture. For example, and as shown in FIGS. 6A, 7A, and 8A, at least some of the plurality of reinforcement panels 230 may comprise a projection 248 extending from the reinforcement panel second face 240. The projection 248 may overlap with one of the horizontal ribs 214 below the mounting aperture the reinforcement panel 230 is mounted to, thereby resting the weight of the reinforcement panel 230 on the horizontal rib below the mounting aperture.

Additionally or alternatively, although not illustrated, the plurality of reinforcement panels 230 may be engaged with one of the plurality of horizontal ribs 214 above the mounting aperture though the projection 248, thereby hanging the weight of the reinforcement panel 230 on the horizontal rib above the mounting aperture.

Alternatively to the previous, at least some of the reinforcement panels 230 may be sized to form a close fit in one or more of the sub-panels 216 of the grid, such that at least a portion of the reinforcement panel lower edge 237 is adjacent to one of the horizontal ribs 214. Optionally, at least a portion of the reinforcement panel rear edge 235 may be disposed proximate or adjacent to one of the plurality of vertical ribs 213 and at least a portion of the reinforcement panel 230 front edge 206 may be disposed proximate or adjacent to another of the plurality of vertical ribs 213.

Without being limited by theory, the reinforcement panel 230 being engaged with one of the horizontal ribs 214, such as through the projection 248, may be desired due to the principles of creep and stress concentration with regards to snap fittings. Particularly, stress concentration may refer to a phenomenon where a small portion of the snap fitting 241 is much more heavily loaded than other parts. If the stresses in these areas exceed material strength limits, the snap fitting 241, and thus the overall structure, fails. Further, creep is a phenomenon where a material becomes weak over a long period of time under stress. Since snap fittings remain loaded for extended time periods, they may experience creep which may compromise their structural integrity.

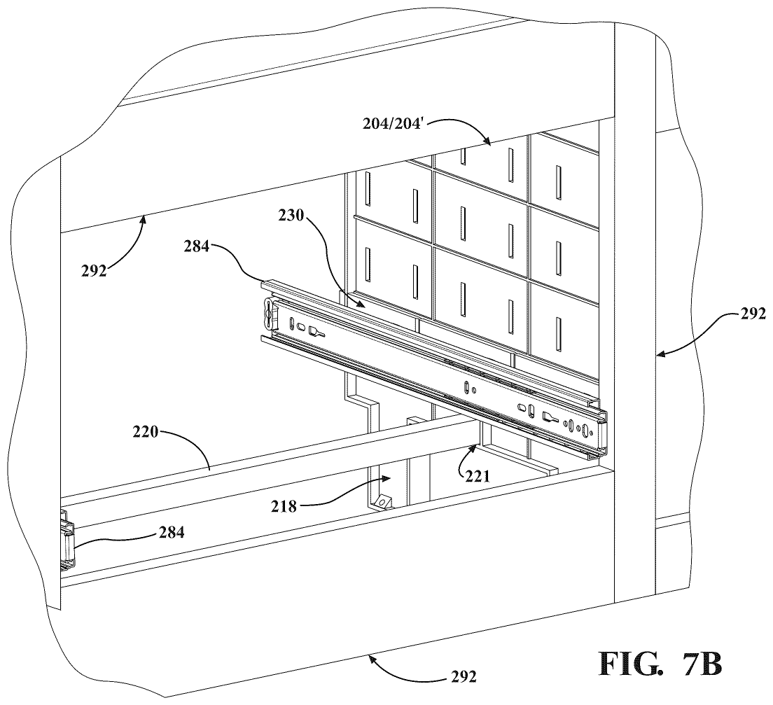

As previously stated, in some embodiments at least a portion of the reinforcement panel lower edge 237 is adjacent to one of the horizontal ribs 214. However, as shown in FIGS. 5-8B, at least some of the reinforcement panels 230 may span at least two sub-panels 216 of the grid in a horizontal direction. This is shown for example, in the reinforcement panels of FIGS. 6A-7B. Accordingly, to span the vertical ribs, the reinforcement panels 230 may further comprise one or more reinforcement panel recesses 243 sized to fit over at least one of the plurality of vertical ribs 213.

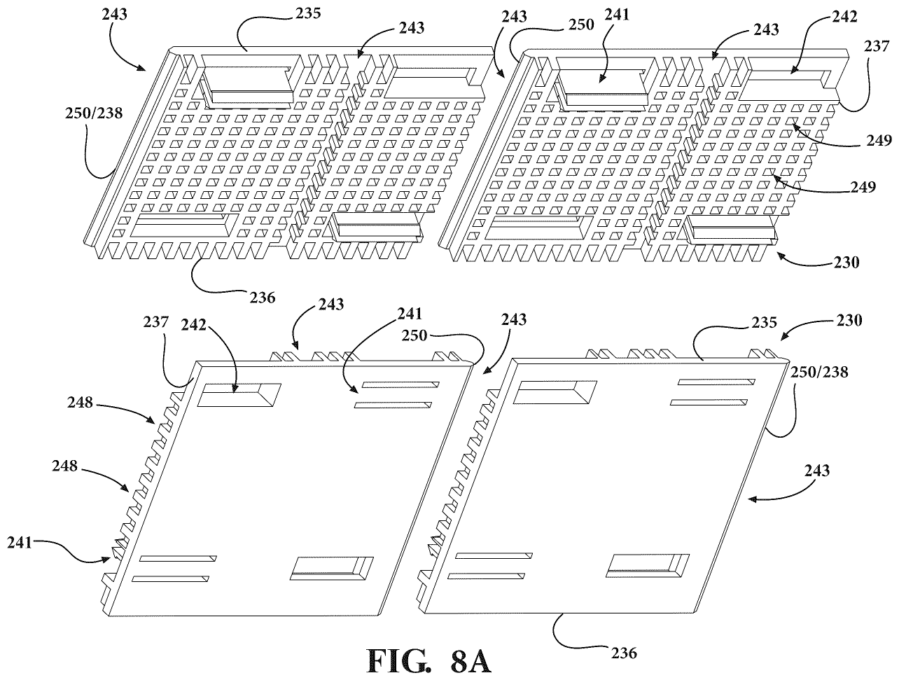

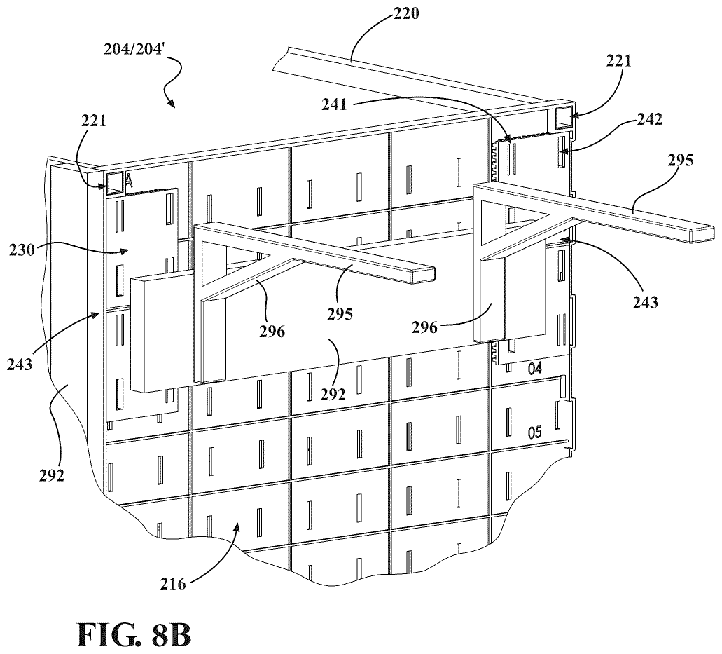

Additionally or alternatively, at least some of the reinforcement panels 230 may span at least two sub-panels 216 of the grid in vertical direction. This is shown for example, in the reinforcement panels of FIGS. 8A-8B. Accordingly, to span the horizontal ribs, the one or more reinforcement panel recesses 243 may be sized to fit over one of the plurality of horizontal ribs 214.

Moreover, as shown in at least FIG. 8A as compared to FIG. 8B, at least some of the plurality of reinforcement panels 230 may be configured to be frangible at the reinforcement panel recesses 243, such that at least some of the reinforcement panel 230 may be configurable to a desired length. For example, and as shown in FIGS. 6A-8B, a thickness of the reinforcement panel 230 along the reinforcement panel recesses 243 may gradually decrease to a snapping point 250, such that the reinforcement panel 230 recess 297 is more frangible at the snapping point 250 than the remaining portion of the reinforcement panel 230 recess 297.

Still referring to FIGS. 8A-8B, at least some of the plurality of reinforcement panels 230 may further comprise a plurality of indentations 249 extending into the reinforcement panel second face 240. Without being limited by theory, the plurality of indentations 249 may ease the insertion of fasteners such as screws or nails or staples into the reinforcement panel 230, such as for mounting the plurality of cosmetic panels 292 or any external features, as described in further detail herein.

Still referring to FIGS. 5-8B, it is contemplated that set pairs of the plurality of reinforcement panels 230 may be configured to nest within each other from the opposite first and second panel faces 209/210.

Particularly, as previously stated, at least one of the sub-panels of the grid may comprise two or more mounting apertures 217. At least two of the plurality of reinforcement panels (the set pair) may comprise a matching aperture 242 configured to align with one of the two mounting apertures 217 of the said sub-panel 216 of the grid. The matching aperture 242 may be configured to extend through the first and second reinforcement panel faces 239/240, similar to the plurality of mounting apertures 217. The matching aperture 242 may also be spaced such that the matching aperture 242 overlaps one of the two mounting apertures 217 and the snap fitting 241 of the reinforcement panel 230 overlaps the other of the two mounting apertures 217 when the said at least two reinforcement panels 230 are anchored to one of the two mounting apertures 217 of the said sub-panel 216. Further, the said at least two reinforcement panels 230 comprising the matching apertures 242 may be configured to anchor to opposing faces of the said sub-panel 216 by their respective snap fittings 241, thereby nesting the two reinforcement panels.

As previously stated, at least FIGS. 6A-8B are intended to show the reinforcement panels 230 individually (6A, 7A, 8A) as well as various placement of the various reinforcement panels 230 mounted on the plurality of side panels 204 (6B, 7B, 8B).

Now referring to FIGS. 6A-6B, illustrated is a ‘ledge-type’ reinforcement panel 230. Particularly, as shown in FIG. 6A, at least some of the plurality of reinforcement panels 230 may comprise a ledge 245 extending from the reinforcement panel first face 239. As also shown in FIG. 6A, the reinforcement panel 230 may further comprise a supporting bracket 246 in contact with the ledge 245 and configured to support the ledge 245. Still referring to FIG. 6A, the reinforcement panel may further comprise cross-bracing 247 disposed on and extending from the reinforcement panel second face 240. The cross-bracing 247 may be configured to provide additional support to the ledge 245 and the supporting bracket 246. Further, the cross-bracing 247 may be coupled to, or monolithic (in one solid piece) with the projection 248. As shown in FIG. 6B, the reinforcement panel 230 may also be configured to support the weight of one or more shelves 280, such as through the ledge 245. However, it is contemplated that the reinforcement panels may also be configured to support the weight of one of a number of items, including but not limited to a kitchen fixture such as the oven illustrated in FIGS. 1-2B.

Now referring to FIGS. 7A-7B, illustrated is a ‘drawer-type’ reinforcement panel 230. Particularly, as shown in FIG. 7A, at least some of the plurality of reinforcement panels 230 may comprise a guide hole 244 extending through the reinforcement panel first and second faces 239/240. The guide hole 244 may be configured to receive a fastener, such as any of the previous fasteners discussed, for securing an external component to the reinforcement panel 230. For example, and as shown in FIG. 7B, a drawer slide 284 may be coupled through the fastener to the reinforcement panel 230, for subsequently placing the one or more drawers 285 (as shown in FIG. 2B) into the cabinet structure 200. Furthermore, to support the weight of the drawer slide 284 and the drawer 284, the reinforcement panel second face 240 may further comprise the cross-bracing 247 positioned around the guide hole 244.

Now referring to FIGS. 8A-8B, illustrated is a ‘support-type’ reinforcement panel 230. Particularly, at least some of the reinforcement panels 230 may have a thickness configured to provide additional support for an external component. For example, as shown in at least 8B, external components such as an external ledge 295 and/or an external ledge supporting bracket may be mounted on the reinforcement panel 230, such as by affixing a fastener through the reinforcement panel 230 and optionally the side panel 204 itself. Although not directly shown in FIGS. 2A-2B, the reinforcement panel 230 may be mounted to one of the plurality of side panels 204 for supporting a hinge, such as an overlay hinge, for supporting doors for the one or more cabinets 286.

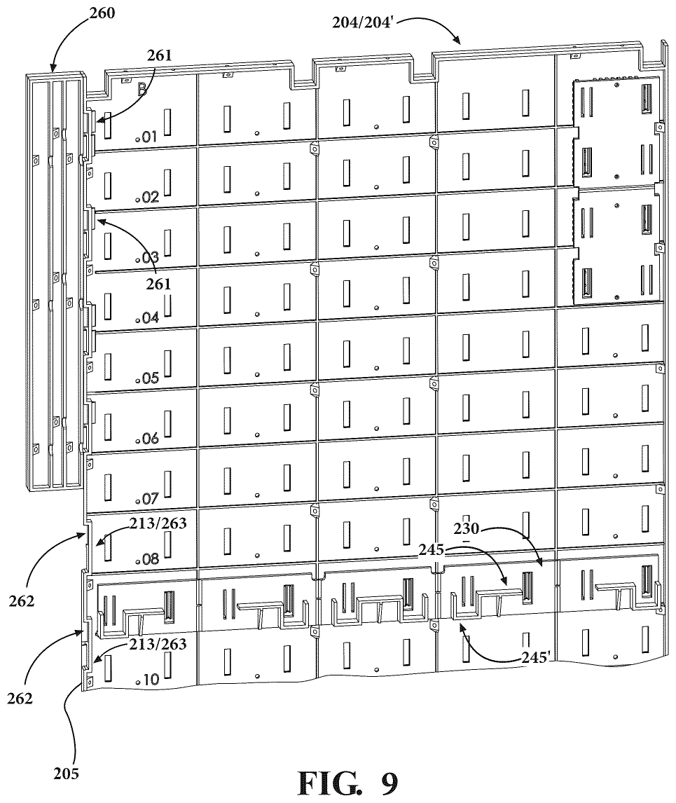

It is contemplated that while the previous features of the reinforcement panels 230 were described with reference to FIGS. 5-8 individually, as well as with respect to FIG. 9 as discussed below, there may be mixing and matching of any of the features/components of the reinforcement panels to fit the particular application.

As previously stated, the cabinet structure 200 may further comprise the one or more cosmetic panels 292. As shown in at least FIGS. 2A-2B, the plurality of cosmetic panels 292 each may be disposed on an exterior of one of the plurality of side panels 204. The plurality of cosmetic panels 292 may be coupled to at least one of the rear edge 205, the front edge 206, the upper edge 208, the lower edge 207, the first panel face 209, or the second panel face 210 of at least one of the plurality of side panels 204. However, as shown in at least FIG. 8B, at least some of the plurality of cosmetic panels 292 may be coupled to the reinforcement panels 230, such as at the reinforcement panel first face 239. Accordingly, the plurality of cosmetic panels 292 may cooperate to substantially obscure both the plurality of side panels 204 and the plurality of reinforcement panels 230 from an exterior view.

Now referring to FIGS. 2A-3B as well as FIG. 9, as previously stated, the cabinet structure 200 may also comprise the countertop 289. It is contemplated that, according to customer preference, it may be desired to extend a depth of the countertop 289 in some applications. Accordingly, this may be balanced with a counteracting desire to make the plurality of side panels 204 of generally the same dimensions across different cabinet structures 200, in order to allow upscaling of manufacture. Consequently, to obviate the need for adjusting the size of the plurality of side panels 204 for each and every customer preference, the cabinet structure 200 may further comprise a panel extension 260 which may be configured to mount to the rear edge 205 of at least some of the plurality of side panels 204. The panel extension 260, through its thickness, may be configured to extend a length of the plurality of side panels 204, and thereby permit the installation of extended depth countertops.

As previously stated, the cabinet structure 200 may further comprise one or more panel extensions 260, which may be configured to mount to the rear edge 205 of at least some of the plurality of side panels 204, such as to increase the countertop 289 depth. As shown by the combination of at least FIGS. 5 and 9, the one or more panel extensions 260 may be configured to mount to the rear edge 205 by utilizing one of the plurality of vertical ribs 213 placed proximal to the rear edge 205.

For example, and still referring to FIGS. 2A-3B as well as 9, the one or more panel extensions 260 may comprise a plurality of panel extension snap fittings 261 that are configured to anchor to the vertical rib 213 placed proximal to the rear edge 205, such as any of the types of snap fittings hereinbefore discussed. For example, at least some of the plurality of panel extension snap fittings 261 may be cantilever-type snap fittings. In such embodiments, the vertical rib 213 placed proximal to the rear edge 205 may further comprise a plurality of rib mounting apertures 262 extending through the thickness of the vertical rib 213, the rib mounting apertures 262 oriented substantially parallel to the first panel face 209 or the second panel face 210.

As also shown in FIGS. 5 and 9, the vertical rib 213 placed proximal to the rear edge 205 may be of a relatively greater thickness as compared to at least some of the remaining plurality of vertical and horizontal ribs 213/214 so as to have space for the plurality of rib mounting apertures 262 within the thickness.

Still referring to FIGS. 5 and 9, the vertical rib 213 placed proximal to the rear edge 205, as well as the side panel 204 itself, may comprise a plurality of internal offsets 263 for receiving the plurality of panel extension snap fittings 261. In such embodiments, the plurality of panel extension snap fittings 261 may be spaced such at least some of the panel extension snap fittings 261 are adjacent a bottom edge of at least some of the plurality of internal offsets 263, and at least some of the panel extension snap fittings 261 are adjacent a top edge of at least some of the plurality of internal offsets 263. In so being configured, the plurality of internal offsets 263 may help support the weight of the panel extension 260, such that the risk of the plurality of panel extension snap fittings 261 shearing due to the weight of the panel extension 260 is reduced.

Further, in so being configured, the combination of the plurality of internal offsets 263 and the plurality of panel extension snap fittings 261 may form a tight fit, such that there is substantially no ‘play’ or wiggle room in the mating of the extension panel 260 and the side panel 204.

Now referring to FIGS. 6A and 9, and as previously stated, at least some of the plurality of reinforcement panels 230 may comprise the ledge 245. Further, as previously stated, the reinforcement panel 230 may also be configured to support the weight of an associated component. As shown in FIG. 9, the ledge 245 may further comprise at least one offset ledge 245′ for supporting and/or securing at least one of the tubular supports 220.

It is noted that recitations in the present disclosure of a component of the present disclosure being “configured”, “operable”, or “sufficient” in a particular way, to embody a particular property, or to function in a particular manner, are structural recitations, as opposed to recitations of intended use. More specifically, the references in the present disclosure to the manner in which a component is “configured”, “operable”, or “sufficient” denotes an existing physical condition of the component and, as such, is to be taken as a definite recitation of the structural characteristics of the component.

It is also noted that recitations herein of “at least one” component, element, etc., should not be used to create an inference that the alternative use of the articles “a” or “an” should be limited to a single component, element, etc. The singular forms “a,” “an” and “the” include plural referents, unless the context clearly dictates otherwise.

Throughout this disclosure ranges are provided. It is envisioned that each discrete value encompassed by the ranges are also included. Additionally, the ranges which may be formed by each discrete value encompassed by the explicitly disclosed ranges are equally envisioned.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.” It is noted that the use of the terms “having” or “including”, or grammatical variations thereof, in this disclosure should also be interpreted in like manner as the more commonly used open-ended preamble term “comprising”.

As used in this disclosure, terms such as “first” and “second” are arbitrarily assigned and are merely intended to differentiate between two or more instances or components. It is to be understood that the words “first” and “second” serve no other purpose and are not part of the name or description of the component, nor do they necessarily define a relative location, position, or order of the component. Furthermore, it is to be understood that the mere use of the term “first” and “second” does not require that there be any “third” component, although that possibility is contemplated under the scope of the present disclosure.

Having described the subject matter of the present embodiments herein in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present embodiments including, but not limited to, embodiments defined in the appended claims. More specifically, although some aspects of the present embodiments are identified herein as preferred or particularly advantageous, it is contemplated that the present embodiments is not necessarily limited to these aspects.

What is claimed is:

1. A recreational vehicle of the type comprising a chassis with at least one axle, the recreational vehicle comprising:
a generally horizontal floor;
a vehicle body comprising a plurality of generally upstanding walls each comprising a bottom adjacent the floor and a top distal to the floor; and
a cabinet structure in contact with one of the upstanding walls, the cabinet structure comprising
a plurality of generally planar side panels, each of the plurality of side panels comprising:
a rear edge disposed proximate to one of the upstanding walls;
an opposed front edge distal to one of the upstanding walls;
a lower edge;
an upper edge distal to the floor;
opposed first and second panel faces extending generally between the front and rear edges and the upper and lower edges; and
a plurality of channels extending between the first and second side panel faces, and
a plurality of tubular supports, wherein:
each tubular support is sized to fit through the channels of the plurality of side panels;
each tubular support extends from the channel of one of the plurality of side panels to a corresponding channel of another of the plurality of side panels; and
the tubular supports interconnect the plurality of sides panels, thereby providing rigidity to the cabinet structure.

2. The recreational vehicle of claim 1, wherein the plurality of side panels further comprises a plurality of openings extending between the first and second side panel faces.

3. The recreational vehicle of claim 2, wherein at least two of the plurality of side panels further comprise a plurality of ledges adjacent at least one of the plurality of openings.

4. The recreational vehicle of claim 1, wherein each side panel further comprises a plurality of guide holes.

5. The recreational vehicle of claim 4, wherein the cabinet structure further comprises a plurality of reinforcement panels, each reinforcement panel comprising:
a reinforcement panel rear edge;
an opposed reinforcement panel front edge to the reinforcement panel rear edge;
a reinforcement panel lower edge;
an opposed reinforcement panel upper edge to the reinforcement panel lower edge; and
a reinforcement panel first face and an reinforcement panel second face opposing each other and extending generally between the front and rear edges and the upper and lower edges, wherein
the reinforcement panel second face is adjacent to one of the first or second panel faces of the side panel, and
the plurality of reinforcement panels are each anchored to the one of the first or second panel faces of the side panel via the plurality of guide holes.

6. The recreational vehicle of claim 5, wherein the cabinet structure further comprises:
one or more drawer slides coupled to at least one of the plurality of reinforcement panels;
one or more drawer slides coupled to at least one of the guide holes;
one or more overlay hinges coupled to at least one of the plurality of reinforcement panels;
one or more overlay hinges coupled to at least one of the guide holes;
one or more ledges coupled to at least one of the plurality of reinforcement panels;
one or more ledges coupled to at least one of the guide holes; or
combinations thereof.

7. The recreational vehicle of claim 4, wherein the cabinet structure further comprises
one or more drawer slides coupled to the guide holes;
one or more overlay hinges coupled to the guide holes;
one or more ledges coupled to the guide holes; or
combinations thereof.

8. The recreational vehicle of claim 1, wherein the plurality of side panels are perpendicular to at least one of the plurality of upstanding walls.

9. The recreational vehicle of claim 1, wherein:
the cabinet structure further comprises a plurality of cosmetic panels coupled to at least one of the rear edge, the front edge, the upper edge, the lower edge, the first panel face, or the second panel face of at least one of the plurality of side panels; and
the plurality of cosmetic panels cooperate to substantially obscure the said rear edge, front edge, upper edge, lower edge, first panel face, second panel face, or combinations thereof of the plurality of side panels from an exterior view.

10. The recreational vehicle of claim 1, wherein:
the cabinet structure further comprises a second plurality of generally planar side panels perpendicular to the first plurality of generally planar side panels, each of the second plurality of side panels comprising:
a rear edge distal to the first and second panel faces of the first plurality of side panels,
an opposed front edge proximal to the first and second panel faces of the first plurality of side panels,
a lower edge,
an upper edge distal to the floor,
opposed first and second panel faces extending generally between the front and rear edges and upper and lower edges, and
a plurality of channels extending between the first and second side panel faces of the second plurality of side panels;
at least one of the tubular supports comprises an elbow joint, such that the tubular support extends from the channel of one of the first plurality of side panels to a corresponding channel of one of the second plurality of side panels; and
the tubular supports interconnecting the first and second pluralities of side panels provides rigidity to the cabinet structure.

11. The recreational vehicle of claim 1, wherein the cabinet structure further comprises a panel extension interposed between the rear edge of each of the plurality of side panels and the upstanding wall the rear edge is proximate to.

12. The recreational vehicle of claim 1, wherein, in at least two of the side panels, a portion of the rear edge is spaced from the upstanding wall.

13. The recreational vehicle of claim 1, wherein the cabinet structure further comprises a countertop positioned on the upper edge of at least two of the side panels.

14. The recreational vehicle of claim 1, wherein each the plurality of side panels further comprises a plurality of mounting apertures extending from the first panel face to the second panel face.

15. The recreational vehicle of claim 14, wherein:
each of the plurality of side panels further comprises a plurality of generally vertical and generally horizontal ribs extending from the first panel face, the second panel face, or both;
the plurality of generally vertical and generally horizontal ribs are interconnected, such that they together define a plurality of sub-panels arranged in a grid; and
at least one of the sub-panels of the grid comprises at least one of the plurality of mounting apertures.

16. The recreational vehicle of claim 15, wherein each of the sub-panels of the grid comprise at least one of the plurality of mounting apertures.

17. The recreational vehicle of claim 14, wherein the cabinet structure further comprises a plurality of reinforcement panels, each reinforcement panel comprising:
a reinforcement panel rear edge;
an opposed reinforcement panel front edge;
a reinforcement panel lower edge;
a reinforcement panel upper edge distal to the reinforcement panel lower edge;
a reinforcement panel first face and an reinforcement panel second face opposing each other and extending generally between the front and rear edges and the upper and lower edges, wherein
each of the plurality of reinforcement panels are configured to anchor to at least one of the plurality of mounting apertures,
the reinforcement panel second face is adjacent to one of the first and second panel faces of the side panel, and
at least one reinforcement panel is engaged with one of the horizontal ribs and is anchored to the at least one mounting aperture of one of the sub-panels.

18. The recreational vehicle of claim 17, wherein:
at least one of the plurality of reinforcement panels spans at least two sub-panels of the grid in a horizontal direction, and the reinforcement panel second face of the reinforcement panel spanning the at least two sub-panels of the grid further comprises a reinforcement panel recess sized to fit over one of the vertical ribs; or
at least one of the plurality of reinforcement panels spans at least two sub-panels in a vertical direction, and the reinforcement panel second face of the reinforcement panel spanning at least two sub-panels further comprises a reinforcement panel recess sized to fit over one of the horizontal ribs.

19. The recreational vehicle of claim 17, wherein:
at least one of the reinforcement panels comprises a ledge extending from the reinforcement panel first face;
at least one of the plurality of reinforcement panels comprises a guide hole extending through the first and reinforcement panel second faces;
the cabinet structure further comprises a hinge coupled to at least one of the reinforcement panels; or
combinations thereof.

20. A cabinet structure comprising a plurality of generally planar side panels, each of the plurality of side panels comprising:
a rear edge;
an opposed front edge opposite the rear edge;
a lower edge;
an upper edge opposite the lower edge;
opposed first and second panel faces extending generally between the front and rear edges and the upper and lower edges;
a plurality of channels extending between the first and second side panel faces; and
a plurality of tubular supports, wherein:
each tubular support is sized to fit through the channels of the plurality of side panels,
each tubular support extends from the channel of one of the plurality of side panels to a corresponding channel of another of the plurality of side panels, and
the tubular supports interconnect the plurality of sides panels, thereby providing rigidity to the cabinet structure.
